(19) United States
(12) Patent Application Publication
(10) Pub. No.: US 2010/0054185 A1
(43) Pub. Date: Mar. 4, 2010

(54) Wireless Access Network, Communication Quality Management Apparatus, and Wireless Base Station

(76) Inventors: Masaaki Kaneko, Yokohama (JP); Yasuhito Maejima, Yokohama (JP); Masami Takahashi, Yokohama (JP); Hiroya Kai, Yokohama (JP); Masaki Kanazawa, Kawasaki (JP); Yoshikazu Taoda, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/486,844

(22) Filed: Jun. 18, 2009

(30) Foreign Application Priority Data
Sep. 3, 2008 (JP) 2008-225444

(51) Int. Cl. H04W 4/00

(52) U.S. Cl. 370/328

(57) ABSTRACT

A communication quality management equipment connected via a control line to a plurality of wireless base stations within a wireless access network, acquires quality information of a wireless line at a present position of a mobile terminal, resource information as to a wireless line of each of the wireless base stations, and use information as to a network line of each of the wireless base stations from the respective wireless base stations in a periodic manner, or in response to an instruction issued from the communication quality management equipment, and then judges a communication quality at each of the present positions of the mobile terminal; forms communication quality map information in which the judged communication qualities have been defined in correspondence with the positional information, and transmits the formed communication quality map information to the mobile terminal in accordance with a request from the mobile terminal.

### INCORPORATION BY REFERENCE

The present application claims priority from Japanese application JP2008-225444 filed on Sep. 3, 2008, the content of which is hereby incorporated by reference into this application.

### BACKGROUND OF THE INVENTION

The present invention generally relates to a wireless access network. More specifically, the present invention is directed to a technique capable of notifying communication quality information containing information about an upper hierarchy network than a base station as communication quality information with respect to an end user.

Generally speaking, as means capable of notifying indexes of communication qualities as to mobile terminals (for instance, portable telephones) with respect to users of these mobile terminals, which the mobile terminals can now receive at present places of these users, the below-mentioned display methods have been carried out: That is, number of antenna elements are displayed on display units of these mobile terminals, or characters are displayed thereon, which indicate that these mobile terminals are presently located outside communication service receivable ranges. The above-described number of the antenna elements, or characters indicative of “outside communication service receivable ranges” have been indicated based upon reception strengths of pilot signals transmitted from wireless base stations, which are being presently received by the mobile terminals. However, there are some possibilities that communication lines cannot be connected from a certain wireless base station to mobile terminals, depending upon the following conditions: a total number of mobile terminals which are actually connected with the above-explained certain wireless base station, or communication conditions of these mobile terminals. As a result, such conditions cannot be informed to the users of these mobile terminals by merely displaying the total numbers of the antenna elements and/or the indications of “outside communication service receivable range” based upon the reception strengths of the pilot signals transmitted from the relevant wireless base stations. In addition, even when communication lines could be connected between wireless base stations and mobile terminals, such a situation that users of these mobile terminals cannot receive satisfactory communication services in some cases where an upper hierarchy network than the wireless base stations is brought into a congestion condition, or a certain failure has occurred in this upper hierarchy network.

Also, in wireless access networks, 1xEV-DO (1x Evolution Data-Optimized) and the like have been popularized, and thus, high-speed data communications have been progressed. Similarly, in wireless access networks of next generations, higher speeds of data communications and improvements in data qualities have been considered. In these future wireless access networks, while data communication techniques such as the VoIP (Voice Over IP) system, communication services for requiring higher real-time serviceability have been schemed. As a consequence, it is conceivable that user requirements for information about the below-mentioned items will be considerably made, “users can presently receive how degrees of communication qualities in present wireless communication service areas”, or “users can receive how degrees of communication qualities at which wireless communication service areas.” Under such a circumstance, only such an information related to peripheral wireless communication situations of users as reception strengths of pilot signals may not give sufficient satisfaction to the above-described user requirements in the future. Therefore, necessities as well as importance of providing the below-mentioned communication quality information will be surely increased, while this communication quality information further contains situations about upper hierarchy networks than wireless base stations, for instance, effective throughputs, data delay time, and the like.

In presently available systems capable of measuring/acquiring electric field strengths involved in the above-described communication quality information, vehicles on which electromagnetic wave measuring equipments equipped with the GPS (Global Positioning System) have been mounted have been traveled within areas covered by wireless base stations, in which the electric field strengths should be measured. However, the measuring/acquiring system using the above-mentioned vehicle has the following problem: That is, in this measuring/acquiring system, since electromagnetic wave measurement information as to only such a time range of traveled routes is temporarily acquired, situations as to electromagnetic waves cannot be grasped which change in real time, and moreover, since the above-described measuring operation of the electromagnetic waves is carried out by operators, efficiencies in the measuring operations are deteriorated.

JP-A-2003-204296 has disclosed such a technical idea capable of solving the above-explained problem of the conventional electromagnetic wave measuring method, and also, capable of acquiring data required in electromagnetic wave measurements without employing the electromagnetic wave measuring vehicle. That is, the technical idea disclosed in JP-A-2003-204296 is to acquire the data required in the electromagnetic wave measurements based upon usual communication operations performed by portable terminals owned by ordinary users. Precisely speaking, in this technical idea, while measuring areas and measuring time instants when such electromagnetic wave measurements are carried out with respect to a mobile communication network are instructed, positional data of a portable terminal held by the ordinary user, reception level data of the portable terminal, time instants when the electromagnetic waves were measured, and also predetermined additional information are received. Then, electromagnetic wave strength distributions which are classified in view of at least the measuring area and the time range are calculated based upon the received electromagnetic wave measurement data, and thereafter, an electric field strength distribution is displayed on a map based on the calculated result of the electromagnetic wave strength distribution.

In addition to the above-described conventional data acquiring method, another technical idea has been described in JP-A-2007-124711. That is, this technical idea of JP-A-2007-124711 has a purpose capable of giving such an index to a user who should stay at a present position, or a user who should move to other positions. Accordingly, in accordance with this technical idea, predicted downlink data communication speed information is calculated based upon a total number of portable terminals connected to a wireless base station, and then, is notified to the user.

### SUMMARY OF THE INVENTION

The above-explained conventional technical ideas notify, as the communication quality information, the information as to the electric field strengths of the pilot signals transmitted from the wireless base stations, or the information as to the predicted downlink data communication speeds which have been calculated based upon the total number of the wireless terminals connected to the wireless base station, and thus, notify such information as to wireless sections between the wireless terminals and the base station.

On the other hand, as previously described in the background of the invention, since the highspeed communications of the wireless access networks are required and various sorts of service contents are required, the sufficient satisfaction could not be given to the users when only the communication quality information of the wireless sections is merely notified, as has been performed in the above-explained conventional technique. Therefore, the provision of such as communication quality information which furthermore covers the communication situations of the network having the higher grade from the wireless base stations are necessarily required.

The present invention has been made to solve the above-described problems, and therefore, has an object to notify electric field strength information as to the own mobile terminal of an end user at a present position thereof, and in addition, to notify such a communication quality information which also contains information as to situations on the side of an upper hierarchy network than base stations, for example, communication resource situations of the wireless base stations.

Concretely speaking, the object of the present invention is given as follows: That is, in a wireless access network, as a basis capable of judging a communication service quality of a mobile terminal, a wireless resource situation of a wireless base station and a network condition on the side of an upper hierarchy network than the wireless base station are acquired in combination with positional information and temporal information as to the mobile terminal which is being accessed to the wireless access network. Then, the acquired information is processed in a statistical manner so as to produce statistical information, and the produced statistical information is displayed on a map, and thus, can be notified as area communication quality map information with respect to the end user of the mobile terminal.

To solve the above-described problems, a wireless access network, according to an aspect of the present invention, is featured by such a wireless access network constructed by comprising: a plurality of mobile terminals; a plurality of wireless base stations for performing communications with respect to the plurality of mobile terminals by utilizing wireless signals; and a plurality of packet switching equipments which accommodate thereinto the plurality of wireless base stations and are connected to a plurality of other packet switching equipments via a network line so as to perform packet transfer operations, in which:

a communication quality management equipment is provided which is connected via a control line to the plurality of wireless base stations;

each of the wireless base stations acquires quality information of a wireless line at a present position of such a mobile terminal located within an area covered by the own wireless base station, and calculates both resource information of the wireless line of the area which is covered by the own wireless base station and use information of the network line between the own wireless base station and a packet switching equipment, and then, transmits the quality information of the wireless line at the present position of the mobile terminal acquired from each of the mobile terminals, the wireless resource information of the covered area, and the use information of the network line via the control line to the communication quality management equipment in a periodic manner, or upon receipt of an instruction issued from the communication quality management equipment, in addition:

the communication quality management equipment judges communication qualities at respective positions of the respective mobile terminals based upon the quality information of the wireless lines at the present positions of the respective mobile terminals, the wireless resource information of the covered areas, and the use information of the network lines, which have been transmitted from the plurality of wireless base stations; the communication quality management equipment forms communication quality map information in which the judged communication qualities have been defined in correspondence with the positional information; and the communication quality management equipment transmits the formed communication quality map information to the mobile terminal in accordance with a request issued from the mobile terminal.

In accordance with the present invention, the electric filed strength information as to the own mobile terminal at the present position thereof, and furthermore, the communication quality information containing the information as to the upper hierarchy network than the wireless base station can be notified with respect to the end user of the mobile terminal, while the communication quality information involves the communication resource situation of the wireless base station, and the like.

Also, in the above-described wireless access network, as the basis capable of judging the communication service quality of the mobile terminal, the wireless resource situation of the wireless base station and the network condition on the side of the upper hierarchy network than the wireless base station are acquired in combination with the positional information and the temporal information as to the mobile terminal which is being accessed to the wireless access network. Then, the acquired information is processed in the statistical manner so as to produce the statistical information, and the produced statistical information is displayed on the map, and thus, can be notified as the area communication quality map information with respect to the end user of the mobile terminal.

As a result, the end user can grasp, as the area communication quality map information, such a communication quality information produced by considering not only the peripheral situation of the mobile terminal, but also the situations as to both the wireless base stations and the upper hierarchy network than the wireless base stations. Since the end user can specify such a position where the better communication quality can be achieved based upon the above-explained area communication quality map information, stresses given to the end user during communication operations can be solved.

### BRIEF DESCRIPTION OF THE DRAWINGS

FIG. 1 is a schematic diagram for showing a structure of a wireless access network according to an embodiment of the present invention.

FIG. 2 is a block diagram for representing one example as to a wireless quality management equipment.

FIG. 3 is a block diagram for indicating one example as to a packet switching equipment.

FIG. 4 is a block diagram for representing one example as to a wireless base station.

FIG. 5 is a block diagram for showing one example as to a mobile terminal.

FIG. 6 is an explanatory diagram for describing a communication quality managing sequence of the wireless access network according to the embodiment of the present invention.

FIG. 7 is a diagram for showing a format example as to a notification information packet.

FIG. 8 is a diagram for indicating a format example as to a terminal status notification packet.

FIG. 9 is a diagram for showing a format example as to an area status notification packet.

FIG. 10 is a diagram for representing a format example as to a service quality map request packet.

FIG. 11 is a diagram for representing a format example as to a service quality map acknowledgement packet.

FIG. 12 is a diagram for showing one example as to an electric filed strength rank table.

FIG. 13 is a diagram for indicating one example as to a wireless resource rank table.

FIG. 14 is a diagram for indicating one example as to a backhauls line usage rate rank table.

FIG. 15 is a diagram for showing one example as to a service quality class table.

FIG. 16 is a flow chart for describing a service quality judging/updating process.

FIG. 17 shows an image diagram of a service quality map.

FIG. 18 indicates an image diagram of another service quality map.

FIG. 19 is a flow chart for describing a service map responding process.

### DETAILED DESCRIPTION OF THE INVENTION

Referring now to drawings, a description will be made of various embodiments of the present invention.

(1) Structure of Wireless Access Network of the Present Invention:

Firstly, a description is made of a structure of the wireless access network according to the present invention.

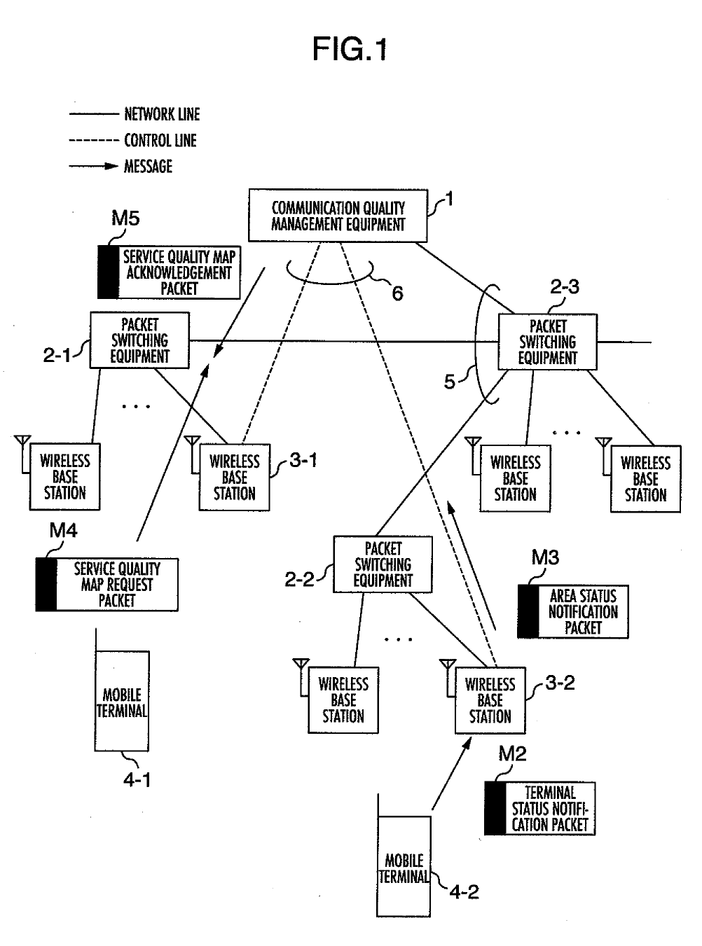

FIG. 1 is a diagram for explaining the structure of the wireless access network according to one embodiment of the present invention.

The wireless access network, according to one embodiment of the present invention, is equipped with a plurality of mobile terminals 4-1 and 4-2, and a plurality of wireless base stations 3-1 and 3-2, which are communicated with these mobile terminals 4-1 and 4-2 by utilizing wireless signals. Although only two sets of the mobile terminals (4-1, 4-2), and only two sets of the wireless base stations (3-1, 3-2) have been illustrated in FIG. 1, two, or more sets of mobile terminals and wireless base stations may be alternatively provided in the structure of the wireless access network. Also, the wireless access network is further equipped with a plurality of packet switching equipments 2-1, 2-2, 2-3, which are connected with each other via a network line 5 so as to transfer reception packets in accordance with a routing table. While each of the packet switching equipments 2-1, 2-2, 2-3 accommodates thereinto a plurality of wireless base stations, a main signal is transmitted/received among these packet switching equipments 2-1, 2-2, 2-3. While the respective wireless base stations 3-1 and 3-2 are further connected via a control line 6 to a communication quality management equipment 1, these wireless base stations 3-1 and 3-2 are controlled by the communication quality management equipment 1.

Also, as viewed from another aspect of the inventive idea, a wireless access network of the present invention is arranged by a packet switching network constituted by a plurality of packet switching equipments; a plurality of base stations which are connected to a terminal of the packet switching network via a network line; a mobile terminal which is connected via a wireless link to the plurality of base stations; and a communication quality management equipment which is connected via a control line to the plurality of wireless base stations.

The wireless access network of the present invention has the below-mentioned features:

That is, each of the wireless base stations 3-1 and 3-2 transmits a notification information packet “M1” with respect to the mobile terminals 4-1 and 4-2 in a periodic manner, or in response to an instruction issued from the communication quality management equipment 1, and then, the mobile terminals 4-1 and 4-2 which have received the above-described notification information packets “M1” measure quality information of wireless lines thereof at the present positions of the mobile terminals 4-1 and 4-2. The mobile terminals 4-1 and 4-2 transmit a terminal status notification packet “M2” containing the measured quality information of the wireless lines with respect to the wireless base stations 3-1 and 3-2 in a periodic manner, or in response to an instruction issued from the communication quality management equipment 1. For instance, the mobile terminal 4-2 transmits the terminal status notification packet “M2” with respect to the wireless base station 3-2 which covers an area where the mobile terminal 4-2 is present.

While the communication quality management equipment 1 has grasped information as to setting positions of the respective wireless base stations, the communication quality management equipment 1 may alternatively instruct to execute a process related to management of the above-described communication quality information with respect to either one or a plurality of selected wireless base stations.

Each of the wireless base stations 3-1 and 3-2 acquires the terminal status notification packet “M2” which is transmitted from a mobile terminal located under the wireless area of the own wireless base station, and calculates a usage rate of a wireless resource in the own wireless base station, and a usage rate of a backhauls line between the own wireless base station and a packet switching equipment in a periodic manner, or in response to an instruction issued from the communication quality management equipment 1, and then, notifies the calculated use rates of the wireless resource and of the backhauls line as an area status notification packet “M3” to the communication quality management equipment 1 in a periodic manner.

The communication quality management equipment 1 acquires the area status notification packet “M3” received from each of the wireless base stations 3-1 and 3-2, and then, forms a service quality map based upon the acquired information In such a case that an end user wants to grasp a service quality as to an area of present position, or a peripheral area of the present position, the end user transmits a service quality map request packet “M4” from a mobile terminal (namely, mobile terminal 4-1 in FIG. 1) with respect to the communication quality management equipment 1. The communication quality management equipment 1 transmits a service quality map acknowledgement packet “M5” responding to the present position of the mobile terminal 4-1 based upon the received service quality map request packet “M4.” The end user can grasp a service quality of the area of present position based upon the service quality map acknowledgement packet “M5.”

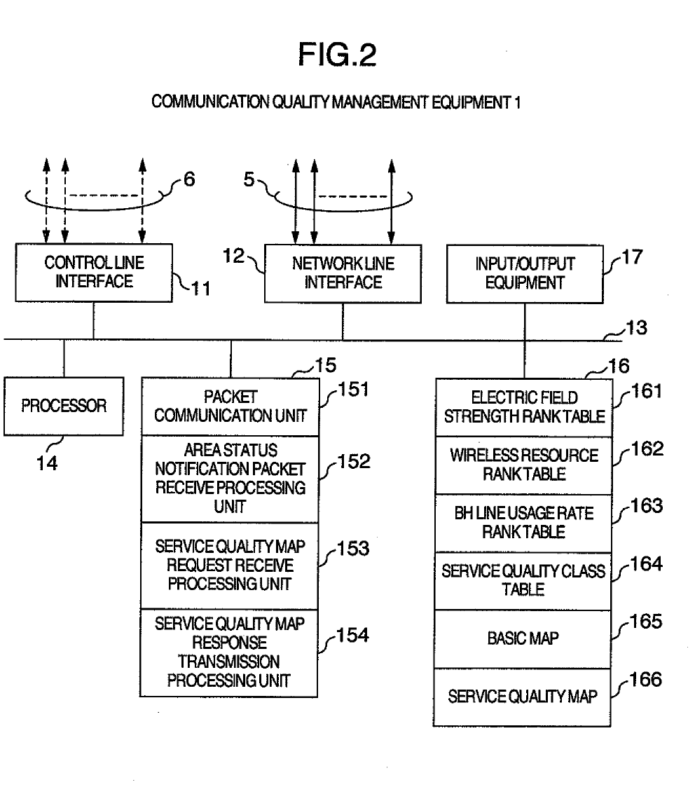

Next, a description is made of an arrangement of a communication quality management equipment with reference to FIG. 2.

(2) Arrangement of Communication Quality Management Equipment 1

FIG. 2 is a block diagram for indicating one embodiment as to the communication quality management equipment 1.

The communication quality management equipment 1 is arranged by employing a control line interface 11 for accommodating thereinto a plurality of control lines 6, a network line interface 12 for accommodating thereinto a plurality of network lines 5, a processor 14, memories 15 and 16, an input/output equipment 17, and an internal bus 13 which connects the above-described elements to each other. The plurality of control lines 6 are connected to a plurality of wireless base stations 3 (namely, 3-1, 3-2, - - - ) under management of the communication quality management equipment 1, respectively.

In the memory 15, as software related to the present invention, which is executed by the processor 14, a packet communication routine (packet communication unit) 151, an area status notification packet reception routine (area status notification packet receive processing unit) 152, a service quality map request reception routine (service quality map request processing unit) 153, and a service quality map response transmission routine (service quality map response transmission processing unit) 154 have been previously prepared.

Also, in the memory 16, as memory areas which store thereinto processed results of the respective routines 151 to 154 of the memory 15 and basic information, an electric field strength rank table 161, a wireless resource rank table 162, a backhauls line usage rate rank table 163, a service quality class table 164, a basic map 165, and a service quality map 166 have been previously formed.

Packets which are transmitted/received from the respective wireless base stations 3 and the respective packet switching equipments 2 via the control line interface 11 and the network line interface 12 are processed for transmission/reception by the packet communication unit 151.

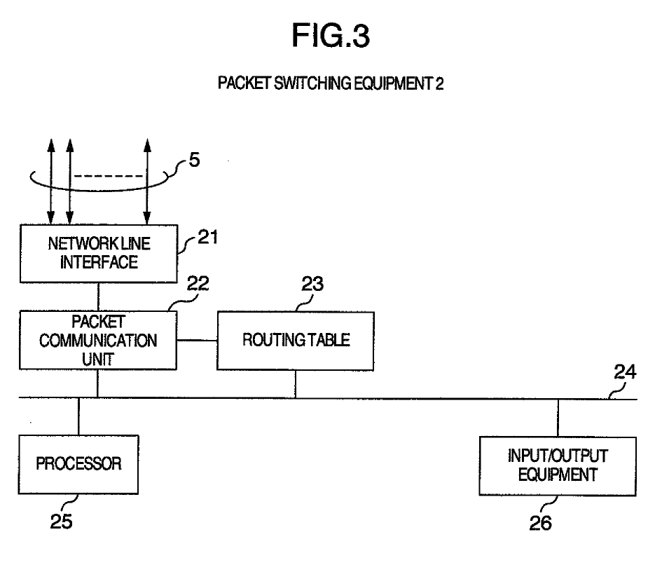

Next, a description is made of a packet switching equipment with reference to FIG. 3.

(3) Arrangement of Packet Switching Equipment 2

FIG. 3 is a block diagram for showing one embodiment as to the packet switching equipment 2.

The packet switching equipment 2 accommodates thereinto a plurality of network lines 5. The packet switching equipment 2 is arranged by employing a network line interface 21, a packet communication unit 22 connected to the network line interface 21, a routing table 23, a processor 25, an input/output equipment 26, and an internal bus 24 which connects the above-described elements with each other. The packet communication unit 22 refers to the above-described routing table 23.

The network line interface 21 has a plurality of line interfaces which correspond to a plurality of network lines to be accommodated.

The packet communication unit 22 sequentially acquires packets received by the network line interface 21, refers to the routing table 23 in accordance with destination addresses indicated by headers of the received packets, and then, transfers the received packets to the corresponding line interfaces in accordance with routing information present in the routing table 23.

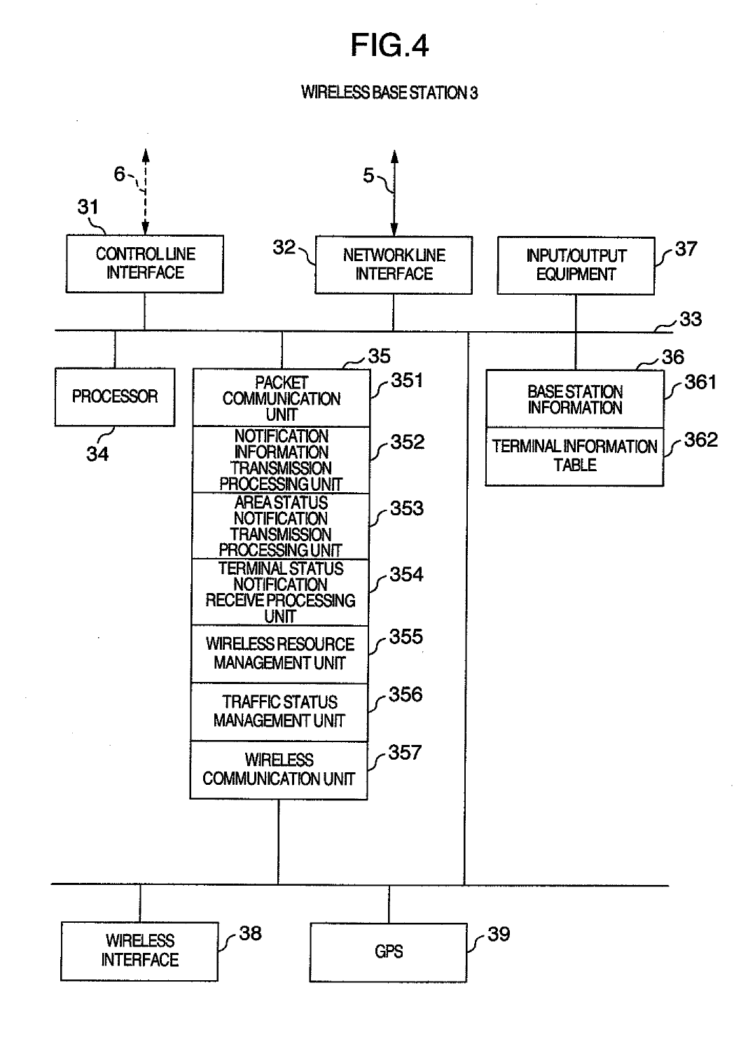

Next, a description is made of a wireless base station with reference to FIG. 4.

(4) Arrangement of Wireless Base Station 3

FIG. 4 is a block diagram for representing one embodiment as to the wireless base station 3.

The wireless base satiation 3 is arranged by employing a control line interface 31 for having accommodated thereinto the control line 6 which is connected to the communication quality management equipment 1, a network line interface 32 for having accommodated thereinto the network line 5 which is connected to the packet switching equipment 2, a wireless interface 38 which is connected to the plurality of mobile terminals 4 (namely, 4-1, 4-2, - - - ), a GPS 39 for measuring positional information of the wireless base station 3, a processor 34, memories 35 and 36, an input/output equipment 37, and an internal bus 33 which connects the above-described elements to each other.

In the memory 35, as software related to the present invention, which is executed by the processor 34, a packet communication routine (packet communication unit) 351, a notification information transmission routine (notification information transmission processing unit) 352, an area status notification transmission routine (area status notification transmission processing unit) 353, a terminal status notification reception routine (terminal status notification receive processing unit) 354, a wireless resource management routine (wireless resource management unit) 355, a traffic status management routine (traffic status management unit) 356, and a wireless communication routine (wireless communication unit) 357 have been previously prepared.

Also, in the memory 36, as a memory area which stores thereinto processed results of the respective routines of the memory 35 and basic information, basestation information 361 and a terminal information table 362 have been previously formed.

A packet which is transmitted to the communication quality management unit 1 is processed for transmission by the packet communication unit 351 via the control line interface 31. Also, packets which have been transmitted/received from the packet switching equipment 2 are processed for transmission/reception by the packet communication unit 351 via the network line interface 32. Also, packets which have been transmitted/received from the mobile terminal 4 are processed for transmission/reception by the wireless communication unit 357 via the wireless interface 38.

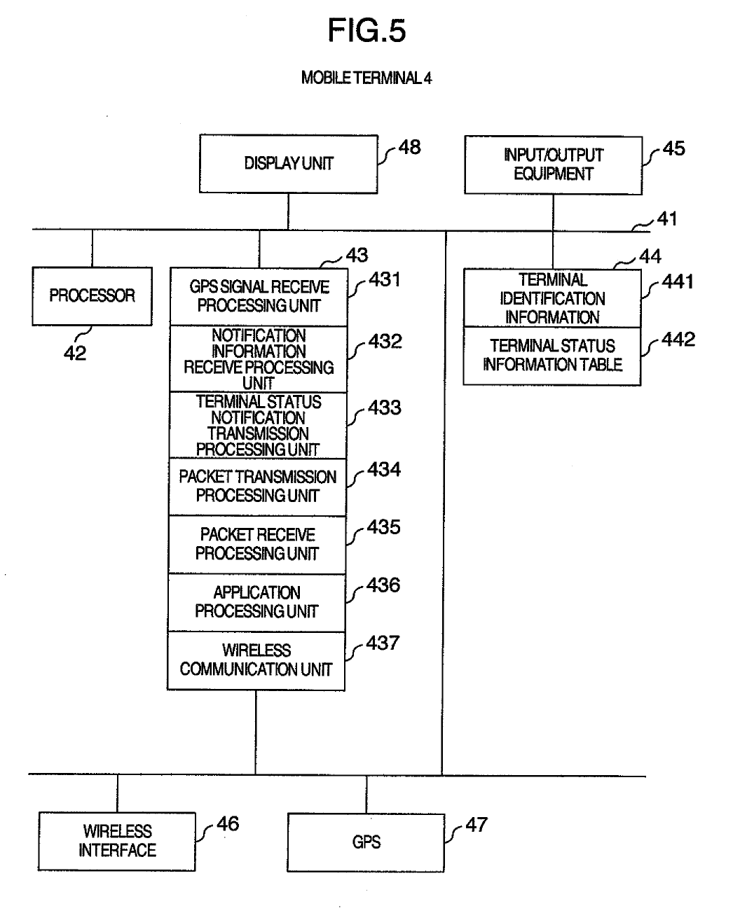

Next, a description is made of a wireless information terminal with reference to FIG. 5.

(5) Arrangement of Mobile Terminal 4

FIG. 5 is a block diagram for showing one embodiment as to the mobile terminal 4.

The mobile terminal 4 is arranged by employing a wireless interface 46 which is connected to the wireless base station 3 (namely, 3-1, 3-2, - - - ), a GPS 47 for measuring positional information of the mobile terminal 4, a processor 42, memories 43 and 44, a display unit 48 for displaying thereon information to be supplied to a user, an input/output equipment 45 for operating the mobile terminal 4 of the user, and an internal bus 41 which connects the above-described elements to each other.

In the memory 43, as software related to the present invention, which is executed by the processor 42, a GPS reception process routine (GPS receive processing unit) 431, a notification information reception process routine (notification information receive processing unit) 432, a terminal status notification transmission process routine (terminal status notification transmission processing unit) 433, a packet transmission process routine (packet transmission processing unit) 434, a packet reception routine (packet receive processing unit) 435, an application program process routine (application processing unit) 436, and a wireless communication process routine (wireless communication unit) 437 have been previously prepared.

Also, in the memory 44, as memory areas which store thereinto processed results of the respective routines of the memory 43 and basic information, terminal identification information 441 and a terminal status information table 442 have been previously formed.

Packets which are transmitted/received with respect to the wireless base station 3 are processed for transmission/reception by the wireless communication unit 437 via the wireless interface 46. In addition, with respect to the above-described packets, a coding process, a decoding process, and other processes are carried out by the packet transmission processing unit 434 and the packet receive processing unit 435, which are required in wireless communications.

Subsequently, a description is made of contents as to communication quality managing processes performed in the wireless access network of the present invention.

(6) Contents as to communication quality managing processes executed in wireless access network of the present invention.

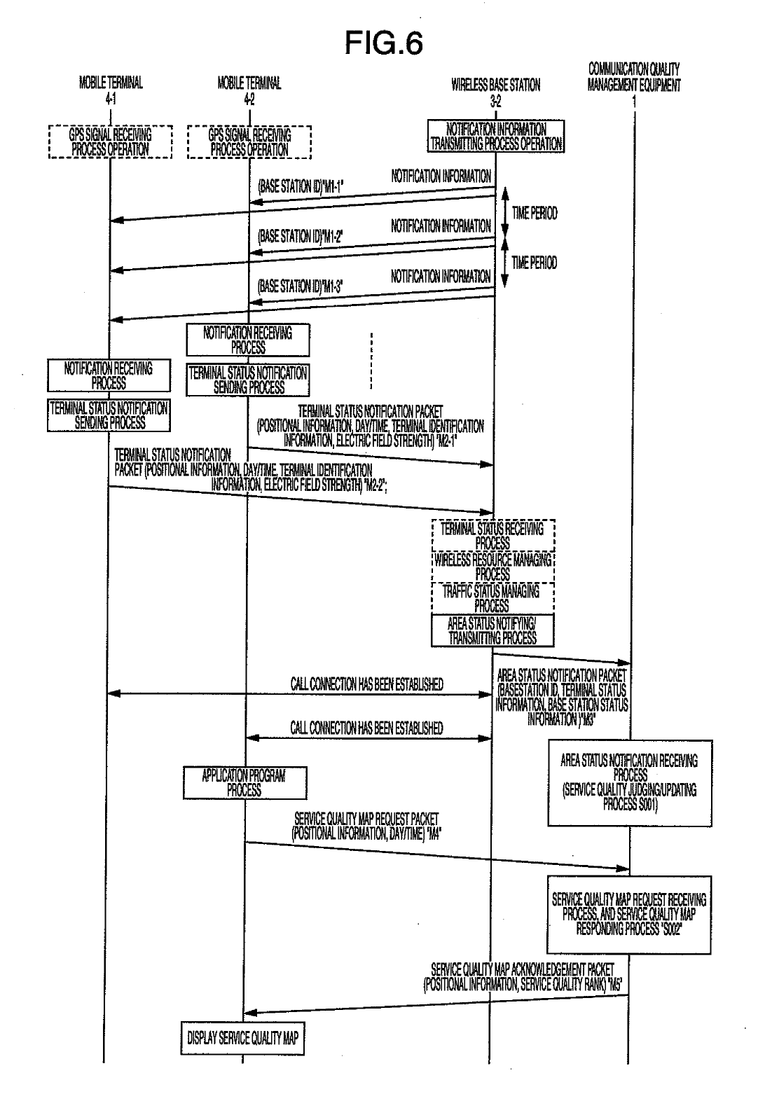

FIG. 6 is a sequence diagram for explaining one embodiment as to communication quality management of the present invention, which is executed among the mobile terminal 4, the wireless base station 3, and the communication quality management equipment 1. In this case, as one example, a description is made of communication quality management executed between the mobile terminals 4-1 and 4-2, and the wireless base station 3-2, and also between the wireless base station 3-2 and the communication quality management equipment 1.

While the mobile terminals 4-1 and 4-2 have the GPSs 47, the processors 42 of the mobile terminals 4-1 and 4-2 execute the GPS signal reception routines 431 in a periodic manner, or in response to operations of the input/output equipments 45 by the users. When the GPS signal reception routine 431 is executed, the processor 42 of the mobile terminal 4 measures a position of the own mobile terminal 4 based upon signals of a plurality of satellites received from the GPS 47, and then, stores the measurement result as positional information 505 in the terminal status information table 442.

The processor 34 of the wireless base station 3-2 executes the notification information process routine 352 in a periodic manner, or in response to an instruction issued from the communication quality management equipment 1. When the notification information process routine 352 is executed, the processor 34 of the wireless base station 3-2 reads base station ID information from the basestation information 361 of the memory 35, and then, stores a base station ID 504 in the notification information packet “M1.”

In addition, the processor 34 of the wireless base station 3-2 transmits the notification information packets “M1” (namely, M1-1, M1-2, M1-3) from the wireless interface 38 via the wireless communication unit 357 with respect to the mobile terminals 4-1 and 4-2 in a periodic manner.

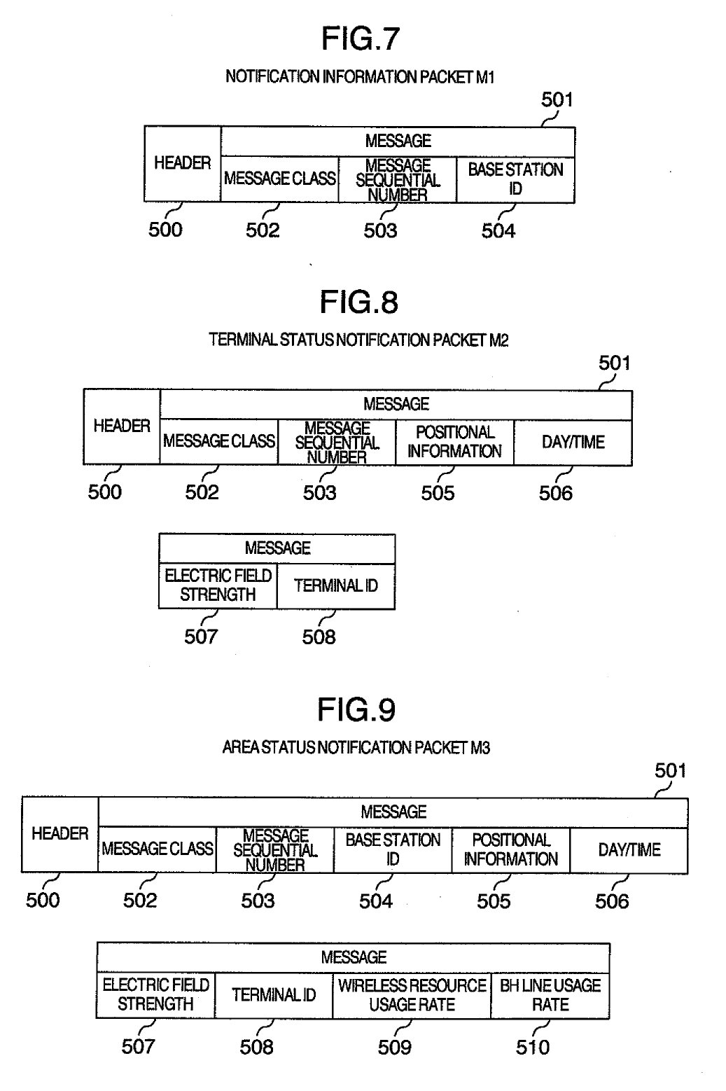

FIG. 7 indicates an example as to a format of a notification information packet “M1.”

As shown in FIG. 7, the notification information packet “M1” is constituted by a header 500 and a message portion 501. The message portion 501 is arranged by employing a message class 502, a message sequential number 503, and a base station ID 504. To the message class 502, a sort code is set which indicates that this message is notification information.

When the mobile terminals 4-1 and 4-2 receive a notification information packet “M1” from the wireless base station 3-2 via the wireless interfaces 46, the mobile terminals 4-1 and 4-2 execute the notification information reception routine 432.

When the notification information reception routine 432 is executed, the mobile terminals 4-1 and 4-2 firstly measure electric field strengths when the notification information packet “M1” was received. Also, the mobile terminals 4-1 and 4-2 read the base station ID 504 from the notification information packet “M1.” In addition, the mobile terminals 4-1 and 4-2 store the base station ID 504 and the electric field strengths 507 in the terminal status information table 442.

Subsequently, the mobile terminals 4-1 and 4-2 execute the terminal status notification transmission routine 433 based upon the notification information packet “M1” notified from the wireless base station 3-2. When the terminal status notification transmission routine 433 is executed, the mobile terminals 4-1 and 4-2 read terminal IDs 508 from the terminal identification 441. Further, the mobile terminals 4-1 and 4-2 read the base station IDs 504, the positional information 505, and the electric field strengths 507 from the terminal status information table 442; and store the above-read respective information in the terminal status notification packets “M2”; and then, transmit the terminal status notification packets “M2” (namely, M2-1 and M2-2) via the wireless interfaces 46 to the wireless base station 3-2.

FIG. 8 shows an example as to a format of the terminal status notification packet “M2.”

As indicated in FIG. 8, the terminal status notification packet “M2” is constituted by a header 500 and a message portion 501. The message portion 501 is arranged by employing a message class 502, a message sequential number 503, positional information 505 acquired from GPS signals and the like, a day/time 506, an electric field strength 507 of the received notification information, and a terminal ID 508.

When the wireless base station 3-2 receives the terminal status notification packets “M2” (namely, M2-1 and M2-2) from the mobile terminals 4-1 and 4-2 via the wireless interface 38, the wireless base station 3-2 executes the terminal status notification reception routine 354.

Since the terminal status notification reception routine 354 is executed by the wireless base station 3-2, the respective values as to the positional information 505, the day/time 506, the electric field strength 507, and the terminal ID 508 of the terminal status notification packet “M2” shown in FIG. 8 are stored in the terminal information table 362.

The wireless base station 3-2 executes the wireless resource management routine 355 in a periodic manner, or in response to an instruction issued from the communication quality management equipment 1. When the wireless resource management routine 355 is executed, the wireless base station 3-2 calculates a wireless free resource which is connected via the wireless interface 38 to the mobile terminal 4, and then, stores the calculated wireless free resource in the basestation information 361 as a wireless resource usage rate.

Also, the wireless base station 3-2 executes the traffic status management routine 356 in a periodic manner, or in response to an instruction issued from the communication quality management equipment 1. When the traffic status management routine 356 is executed, the wireless base station 3-2 calculates a usage rate of a backhauls line which is connected via the network line interface 32 to the packet switching equipment 2, and then, stores the calculation result in the basestation information 361 as a backhauls line usage rate.

The wireless base station 3-2 executes the area status notification transmission routine 353 in a periodic manner, or in response to an instruction issued from the communication quality management equipment 1. When the area status notification transmission routine 353 is executed, the wireless base station 3-2 reads the base station ID 504 of the own wireless base station 3-2, a wireless resource usage rate 509, and a backhauls line usage rate 510 from the basestation information 361. Moreover, when the area status notification transmission routine 353 is executed, the wireless base station 3-2 reads a terminal ID 503, an electric field strength 507, and positional information 505 from the terminal information table 362; and stores the above-explained respective information in the area status notification packet “M3”; and then, transmits the resulting area status notification packet “M3” via the control line interface 31 to the communication quality management equipment 1.

FIG. 9 shows an example as to a format of an area status notification packet “M3.”

As indicated in FIG. 9, the area status notification packet “M3” is constituted by a header 500 and a message portion 501. The message portion 501 is constituted by employing a message class 502, a message sequential number 503, a base station ID 504, positional information 505 as to both the mobile terminals 4-1 and 4-2, a day/time 506, an electric field strength 507, a terminal ID 508, a wireless resource usage rate 509 obtained by executing the wireless resource management routine 355, and a backhauls (BH) line usage rate 510 obtained by executing the traffic status management routine 356.

In FIG. 9, only one set of the positional information 505, the day/time 506, the electric field strength 507, and the terminal ID 508 has been illustrated. Alternatively, plural sets of the positional information 505, the day/times 506, the electric field strengths 507, and the terminal IDs 508 may be contained in a message region in order that information received from the plurality of mobile terminals 4 (4-1, 4-2, - - - ) may be notified by employing one piece of the area status notification packet “M3.”

The communication quality management equipment 1 executes the area status notification packet reception routine 353 based upon the information contained in the area status notification packet “M3” received from the base station 3-2 so as to perform a judging/updating process as to a communication quality. In the below-mentioned description, the communication quality will be referred to as a “service quality” in order to establish a more concrete image thereof.

When the processor 14 of the communication quality management equipment 1 receives an area status notification packet “M3” via the control line interface 11 from each of the wireless base stations 3 (namely, 3-1, 3-2, - - - ), the processor 14 performs the area status notification packet reception routine 152. When the area status notification packet reception routine 152 is executed, the processor 14 of the communication quality management equipment 1 compares the value of the electric field strength 507 stored in the area status notification packet “M3” indicated in FIG. 9 with a value of an electric field strength 1611 described in the electric field strength rank table 161 so as to determine an electric field strength rank 1612.

FIG. 12 is a diagram for showing one example as to the electric field strength rank table 161 which is held by the communication quality management equipment 1. The electric field strength rank table 161 defines the electric field strength rank 1612 based upon the electric field strength 1611. In the present embodiment, the below-mentioned assumptions are made: That is, in such a case that an electric field strength is higher than, or equal to −50 dBm, an electric field strength rank is assumed as 100; in such a case that an electric field strength is equal to −60 dBm to −51 dBm, an electric field strength rank is assumed as 60; in such a case that an electric field strength is equal to −70 dBm to −61 dBm, an electric field strength rank is assumed as 20; and in such a case that an electric field strength is less than, or equal to −71 dBm, an electric field strength rank is assumed as 0.

Similarly, the processor 14 of the communication quality management equipment 1 refers to the wireless resource rank table 162 so as to determine a wireless resource rank 1622 based upon the value of the wireless resource usage rate 509 stored in the area status notification packet “M3.”

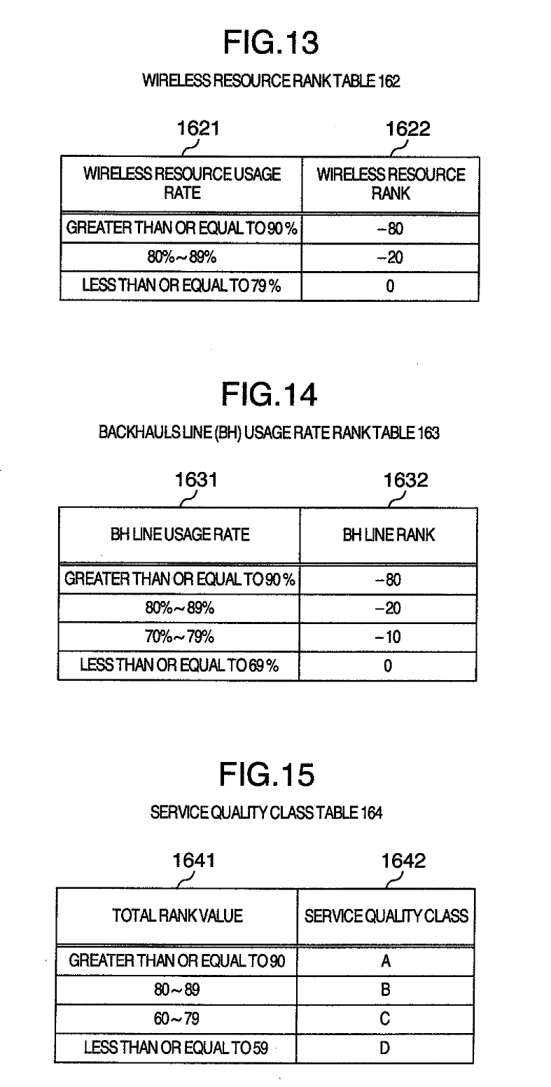

FIG. 13 is a diagram for indicating one embodiment as to the wireless resource rank table 162 which is held by the communication quality management equipment 1. The wireless resource table 162 defines the wireless resource rank 1622 based upon the wireless resource usage rate 1621. In the present embodiment, the below-mentioned assumptions are made: That is, in such a case that a wireless resource usage rate is greater than, or equal to 90%, a wireless resource rank is assumed as −80; in such a case that a wireless resource usage rate is equal to 80% to 89%, a wireless resource rank is assumed as −20; and in such a case that a wireless resource usage rate is smaller than, or equal to 79%, a wireless resource rank is assumed as 0.

In addition, the processor 14 of the communication quality management equipment 1 refers to the backhauls (BH) line usage rate rank table 163 so as to determine a backhauls line rank 1632 based upon the value as to the backhauls line usage rate 510 of the area status notification packet “M3.”

FIG. 14 is a diagram for showing one embodiment as to the backhauls line usage rate rank table 163 which is held by the communication quality management equipment 1. The backhauls line usage rate rank table 163 defines the BH line rank 1632 based upon a BH line usage rate 1631. In the present embodiment, the below-mentioned assumptions are made: That is, in the case that a BH line usage rate is greater than, or equal to 90%, a BH line rank is assumed as −80; in the case that a BH line usage rate is equal to 80% to 89%, a BH line rank is assumed as −20; in the case that a BH line usage rate is equal to 70% to 79%, a BH line rank is assumed as −10; and in the case that a BH line usage rate is smaller than, or equal to 69%, a BH line rank is assumed as 0.

The processor 14 of the communication quality management equipment 1 totalizes the values as to the electric field strength rank 1612, the wireless resource rank 1622, and the backhauls line rank 1632, which have been determined in the above-described manner. Then, the processor 14 of the communication quality management equipment 1 compares the totalized value with the value of the service quality class table 164 so as to determine a service quality class 1642.

FIG. 15 is a diagram for representing one embodiment as to a service quality class table 164 which is held by the communication quality management equipment 1. The service quality class table 164 defines a service quality class 1642 based upon a rank total 1641. The rank total 1641 corresponds to such a value calculated by adding the electric field strength rank 1612, the wireless resource rank 1622, and the BH line rank 1632 with each other. In the present embodiment, the below-mentioned definitions are made: That is, in such a case that a rank total is greater than, or equal to 90, this rank total is defined as a service quality class “A”; in such a case that a rank total is equal to 80 to 89, this rank total is defined as a service quality class “B”; in such a case that a rank total is equal to 60 to 79, this rank total is defined as a service quality class “C”; and in such a case that a rank total is smaller than, or equal to 59, this rank total is defined as a service quality class “D”. Thus, the service quality class 1642 has been segmented into a plurality of ranks “A”, “B”, “C” and “D.”

On the other hand, the processor 14 of the communication quality management equipment 1 specifies a relevant place of a map within a basic map 165 bases upon the value of the positional information 505 stored in the area status notification map “M3”, and stores the value of the above-described service quality class 1642 in a relevant place of a service quality map 166.

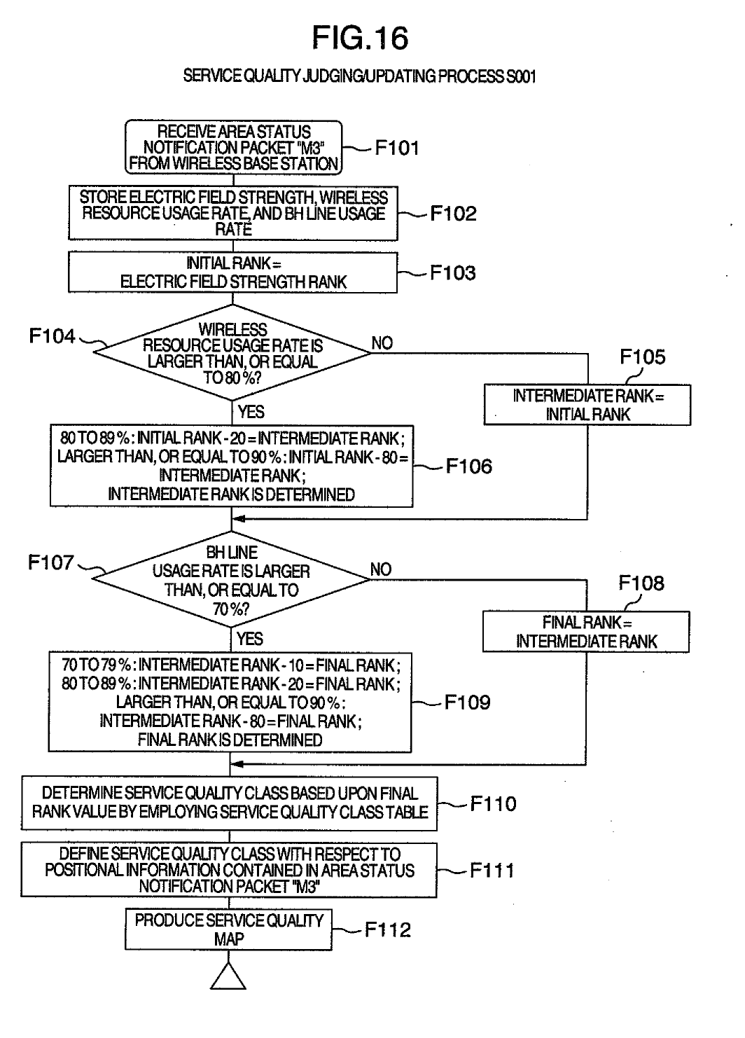

FIG. 16 is a flow chart for describing a service quality judging/updating process “S001” which is executed by the communication quality management equipment 1.

In the service quality judging/managing process “S001”, the communication quality management equipment 1 receives an area status notification packet “M3” from the wireless base station 3 (F101). The communication quality management equipment 1 stores thereinto an electric field strength 507, a wireless resource usage rate 509, and a BH line usage rate 510 from the received area status notification packet “M3” (F102). The communication quality management equipment 1 stores thereinto, as an initial rank, an electric field strength rank 1612 judged based upon the electric field strength rank table 161 shown in FIG. 12 (F103). Next, the communication quality management equipment 1 judges whether or not the wireless resource usage rate 509 has exceeded 80% (F104). In such a case that the wireless resource usage rate 509 has not exceeded 80%, the communication quality management equipment 1 stores the above-described initial rank to an intermediate rank (F105).

In such a case that the wireless resource usage rate 509 has exceeded 80%, the communication quality management equipment 1 adds the wireless resource rank 1622 judged based upon the wireless resource rank table 162 shown in FIG. 13 to the initial rank, and then, stores the added initial rank to an intermediate rank (F106). Next, the communication quality management equipment 1 judges whether or not the BH line usage rate 510 has exceeded 70% (F107). In such a case that the BH line usage rate 510 has not exceeded 70%, the communication quality management equipment 1 stores the intermediate rank to a final rank (F108).

In the case that the BH line usage rate 510 has exceeded 70%, the communication quality management equipment 1 adds the BH line rank 1632 judged based upon the backhauls line usage rate rank table 163 shown in FIG. 14 to the intermediate rank, and then, stores the added intermediate rank in the final rank (F109).

The communication quality management equipment 1 determines a service quality class 1642 by employing the service quality class table 164 shown in FIG. 15 based upon the determined final rank (F110). The communication quality management equipment 1 defines the service quality class 1642 in the positional information 505 of the area status notification packet “M3” (F111). The communication quality management equipment 1 produces a service quality map 166 based upon the service quality class 1642 of the positional information 505 (F112).

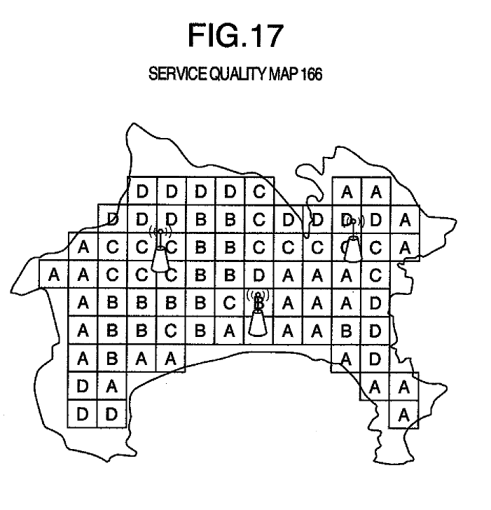

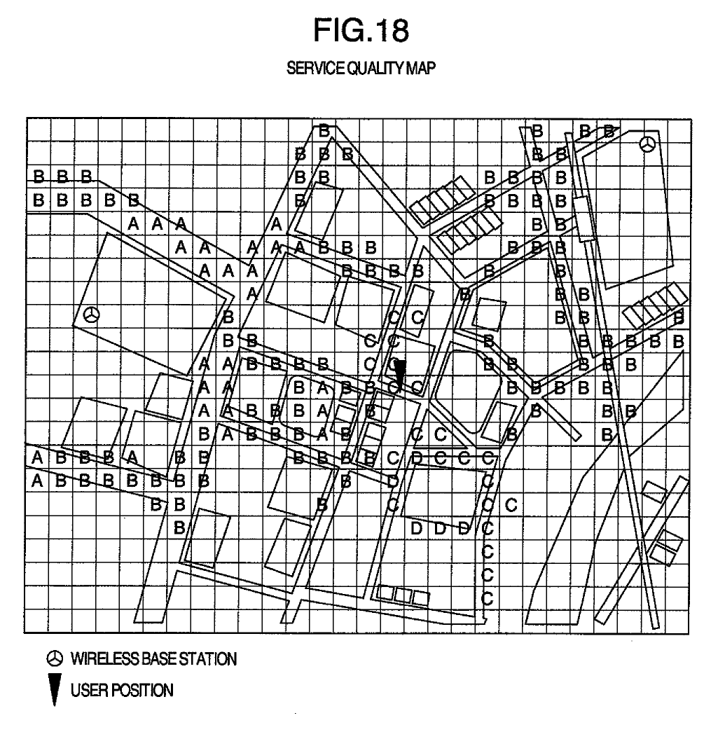

FIG. 17 and FIG. 18 are diagrams for illustratively showing one embodiment as to the service quality map 166 which is held by the communication quality management equipment 1.

The service quality map 166 implies such a map that the service quality class 1642 corresponding to the positional information 505 contained in the area status notification packet “M3” has been mapped on the basic map 165.

In order that an end user requires service quality information, both the mobile terminals 4-1 and 4-2 firstly perform telephone calling operations, and establish call connections with respect to a network side so as to perform packet communications. Next, the mobile terminal 4 (namely, 4-1 and 4-2) executes an application program routine 436. When the mobile terminal 4 executes the application program routine 436, the mobile terminal 4 firstly reads a terminal ID 508 from the terminal identification information 441. In addition, the mobile terminal 4 reads positional information 505 from the terminal status information table 442, and stores the above-described respective information in the service quality map request packet “M4”, and then, transmits the resulting service quality map request packet “M4” via the wireless interface 46 to the respective wireless base stations 3 (namely, 3-1, 3-2). Next, the mobile terminal 4 transmits the above-explained service quality map request packet “M4” to the communication quality management equipment 1.

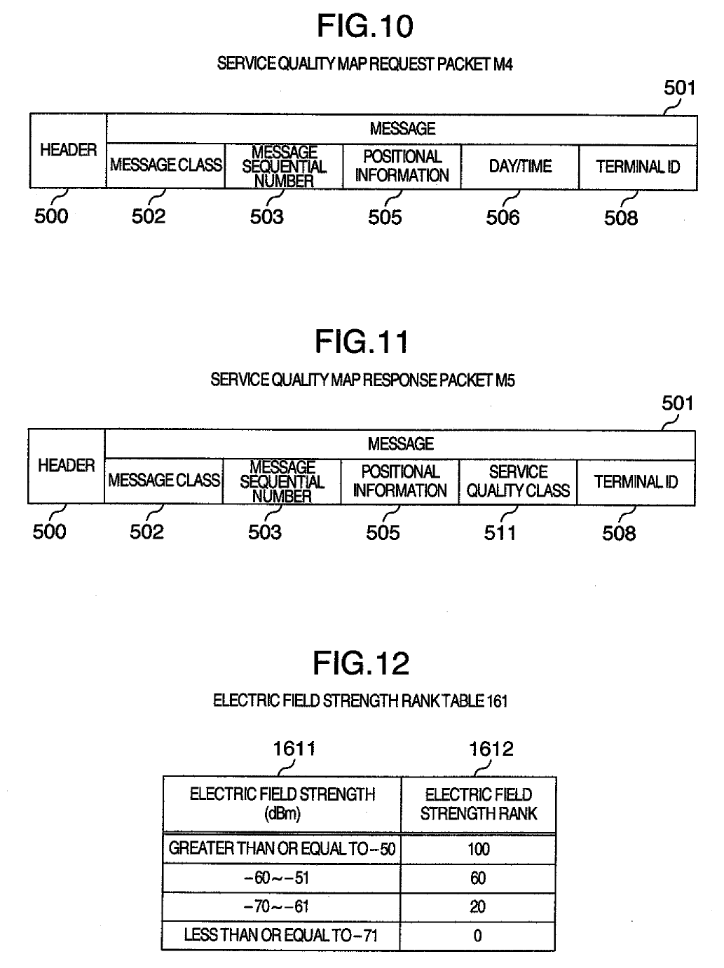

FIG. 10 indicates a format example as to a service quality map request packet “M4.”

As represented in FIG. 10, the service quality map request packet “M4” is constituted by a header 500 and a message portion 501. The message portion 501 is arranged by employing a message class 502, a message sequential number 503, positional information 505, a day/time 506, and a terminal ID 508.

When the processor 14 of the communication quality management equipment 1 receives the service quality map request packet “M4” from the mobile terminal 4 (4-1, 4-2, - - - ) via the respective wireless base stations 3 (3-1, 3-2, - - - ) and the network line interface 12, the processor 14 of this communication quality management equipment 1 executes a service quality map request reception routine 153. When the service quality map request reception routine 153 is executed, the processor 14 of the communication quality management equipment 1 specifies the relevant place of the service quality maps 166 shown in FIG. 17 and FIG. 18, and reads a value of a service quality class 1642 which has been stored in correspondence with this relevant place. When the value of the above-explained service quality class 1642 is read, the processor 14 of the communication quality management equipment 1 executes a service quality map response transmission routine 154.

When the service quality map response transmission routine 154 is executed, the processor 14 of the communication quality management equipment 1 produces a service quality map acknowledgement packet “M5”, and then, writes in the produced service quality map acknowledgement packet “M5”, such a value of the service quality class 1642 which has been read by processing the above-explained service quality map request reception routine 153. In addition, when the service quality map response transmission routine 154 is executed, the processor 14 of the communication quality management equipment 1 specifies the mobile terminal 4-1 as a transmission destination based upon the terminal ID 508 stored in the service quality map request reception packet “M4”, and then, stores the value of this terminal ID 508 in the terminal ID 508 of the service quality map acknowledgement packet “M5.” When the service quality map request transmission routine 154 is executed, the processor 14 of the communication quality management equipment 1 transmits the formed service quality map acknowledgement packet “M5” via the network line interface 12 to the network line 5. Due to the switching function of the packet switching equipment 2 (2-1, 2-2, 2-3, - - - ), the above-explained service quality map acknowledgement packet “M5” is transmitted to the mobile terminal 4-1 having such a terminal ID which has been stored in the region of the terminal ID 508 of the service quality map acknowledgement packet “M5.”

FIG. 11 indicates a format example as to a service quality map response message “M5.”

As represented in FIG. 11, the service quality map response “M5” is constituted by a header 500 and a message portion 501. The message portion 501 is arranged by employing a message source 502, a message sequential number 503, positional information 505, a service quality class 511, and a terminal ID 508.

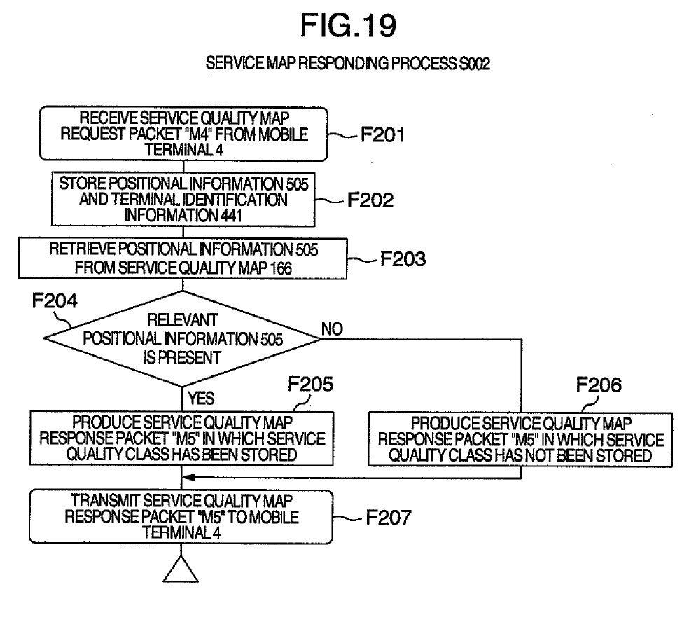

FIG. 19 is a flow chart for describing a service map responding process “S002” which is executed by the communication quality management equipment 1.

When the service map responding process “S002” is executed, the communication quality management equipment 1 receives a service quality map request packet “M4” from the mobile terminal 4 (F201). The communication quality management equipment 1 stores thereinto positional information 505 and a terminal ID 508 from the received service quality map request “M4” (F202). The communication quality management equipment 1 retrieves the service quality map 166 based upon the positional information 505 so as to specify a position of the terminal ID 508 (F203). In such a case that the communication quality management equipment 1 could not specify the position of the terminal ID 508, the communication quality management equipment 1 produces such a service quality map acknowledgement packet “M5” to which the service quality class 511 has not yet been applied (F206).

In such a case that the position of the terminal ID 508 could be specified, the communication quality management equipment 1 produces such a service quality map acknowledgement packet “M5” to which the service quality class 511 has been applied (F205). Then, the communication quality management equipment 1 transmits the produced service quality map acknowledgement packet “M5” to the mobile terminal 4 (F207).

The mobile terminal 4-2 receives the service quality map acknowledgement packet “M5” shown in FIG. 11 from each of the wireless base stations 3 (3-1, 3-2, - - - ) as a response of the above-explained service quality map request packet “M4” by executing an application program routine 436. Then, the mobile terminal 4-2 constructs a service quality map 166 based upon the positional information 505 and the service quality class 511 of the received service quality map acknowledgement packet “M5”, and thereafter, displays the constructed service quality map 166 on the display unit 48 thereof.

As the information which is stored in the service quality map acknowledgement packet “M5” and is transmitted to the mobile terminal 4, in addition to the above-explained information which is subdivided into the positional information 505 and the service quality class 511 so as to be transmitted, while such service quality maps 166 as illustrated in FIG. 17 and FIG. 18 may be previously formed as image information, the image information may be alternatively transmitted. Also, with respect to a range of a service quality map and another range of such an area that information of a service quality class is wanted to be acquired, these ranges may be designated by containing such an information for designating the ranges in the positional information region of the above-explained service quality map request packet “M4.”

In the present embodiment, the below-mentioned case has been exemplified: That is, the electric field strength rank, the wireless resource rank, and the backhauls line rank have been totalized. Alternatively, while the electric filed strength rank, the wireless resource rank, and the backhauls line rank are not merely totalized, but while coefficients, functions, and other items thereof may be previously determined, values of these coefficients and functions may be integrated. Furthermore, instead of the above-described total value and integrated value, an electric field strength rank map may be transmitted in such a manner that information for designating data which is wanted by a user is contained in a service quality map request message. Alternatively, the information as to the wireless resource rank, and the information as to the backhauls line rank may be individually transmitted. In this alternative case, in addition to such a mode that the ranks “A”, “B”, “C”, and “D” illustrated in FIG. 17 and FIG. 18 are indicated on a map, the below-mentioned display modes may be alternatively employed. That is, for instance, when wireless resources are employed, numbers of terminals under connection may be alternatively displayed by employing numeral numbers, or numbers of pictures which indicate these terminals. Alternatively, when usage rates of backhauls lines are employed, the usage rates may be displayed by employing numeral numbers, or graphical representations. Accordingly, such display modes may be alternatively made by which large/small relationships between usage rates of the wireless resources and of the backhauls lines may be grasped in a visual manner.

In accordance with the present invention, since the communication quality management equipment acquires the communication status information as to the mobile terminals and the wireless base stations, which have been connected on the wireless access network, the manager of the communication quality management equipment can grasp the service qualities within the wireless area range which is covered by the wireless base stations on the wireless access network. Also, the service qualities within the wireless area range are transmitted as the service quality maps to the respective mobile terminals, so that the end user can grasp the service qualities which contain the electric field strength information, and in addition, contain the below-mentioned information, namely, the communication resource statuses, the effective throughputs, and the like with respect to the own mobile terminal, the wireless base stations located around the own mobile terminal, and the upper hierarchy network. As a result, these grasped service qualities can be utilized as the indexes capable of receiving the higher service qualities, which can relax the stresses given to the end user.

It should be further understood by those skilled in the art that although the foregoing description has been made on embodiments of the invention, the invention is not limited thereto and various changes and modifications may be made without departing from the spirit of the invention and the scope of the appended claims.

1. A wireless access network constructed by comprising:
a plurality of mobile terminals;
a plurality of wireless base stations for performing communications with respect to said plurality of mobile terminals by utilizing wireless signals; and
a plurality of packet switching equipments which accommodate thereinto said plurality of wireless base stations and are connected to other packet switching equipments via a network line so as to perform packet transfer operations, wherein:
a communication quality management equipment is provided which is connected via a control line to said plurality of wireless base stations;
each of said wireless base stations acquires quality information of a wireless line at a present position of such a mobile terminal located within an area covered by the own wireless base station, and calculates both resource information of the wireless line of the area which is covered by the own wireless base station and use information of the network line between the own wireless base station and a packet switching equipment, and then, transmits the quality information of the wireless line at the present position of said mobile terminal acquired from each of said mobile terminals, the wireless resource information of the covered area, and the use information of the network line via said control line to said communication quality management equipment in a periodic manner, or upon receipt of an instruction issued from said communication quality management equipment; and wherein:
said communication quality management equipment judges communication qualities at respective positions of the respective mobile terminals based upon the quality information of the wireless lines at the present positions of the respective mobile terminals, the wireless resource information of the covered areas, and the use information of the network lines, which have been transmitted from said plurality of wireless base stations;
said communication quality management equipment forms communication quality map information in which said judged communication qualities have been defined in correspondence with the positional information; and
said communication quality management equipment transmits said formed communication quality map information to said mobile terminal in accordance with a request issued from the mobile terminal.

2. A wireless access network as claimed in claim 1 wherein:
said wireless base station transmits notification information to said mobile terminal in a periodic manner, or upon receipt of an instruction issued from said communication quality management equipment; and wherein:
the mobile terminal which has received said notification information measures an electric field strength of an electromagnetic wave received from said wireless base station as the quality information of the wireless line,
acquires positional information of the own mobile terminal, and
transmits the measured electric field strength and the acquired positional information to said wireless base station.

3. A wireless access network as claimed in claim 2 wherein:
the wireless resource information is a usage rate of the wireless resource; and
the use information of the network line is a usage rate of a backhauls line.

4. A wireless access network as claimed in claim 1 wherein:
said judgment result of the communication quality and the positional information thereof are transmitted as said communication quality map information.

5. A communication quality management equipment provided in a wireless access network which is constructed by employing:
a plurality of mobile terminals;
a plurality of wireless base stations for performing communications with respect to said plurality of mobile terminals by utilizing wireless signals;
a plurality of packet switching equipments which accommodate thereinto said plurality of wireless base stations and are connected to other packet switching equipments via a network line so as to perform packet transfer operations; and
the communication quality management equipment which is connected via a control line to said plurality of wireless base stations; wherein:
said communication quality management equipment is comprised of:
quality judging means for receiving wireless line quality information and positional information measured by a mobile terminal within an area of each of said wireless base stations, wireless resource information of each of said wireless base stations, and network line use information of each of said wireless base stations from said respective wireless base stations, and for judging communication qualities based upon said wireless line quality information, said wireless resource information, and said network line use information, which have been received from said respective wireless base stations;
communication quality map updating means for updating a communication quality map in which said judged communication qualities have been defined in correspondence with the measured positions;
communication quality map data storage means for storing thereinto said communication quality map; and
means for transmitting said communication quality map when a communication quality map reception request is issued from each of said mobile terminals.

6. A wireless base station provided in a wireless access network which is constructed by employing:
a plurality of mobile terminals;
a plurality of wireless base stations for performing communications with respect to said plurality of mobile terminals by utilizing wireless signals;
a plurality of packet switching equipments which accommodate thereinto said plurality of wireless base stations and are connected to other packet switching equipments via a network line so as to perform packet transfer operations; and
the communication quality management equipment which is connected via a control line to said plurality of wireless base stations; wherein:
said wireless base station is comprised of:
means for calculating a usage rate of a wireless resource in the own wireless base station;
means for measuring a usage rate of a network line being connected via a packet switching network with the own wireless base station;
means for storing thereinto the usage rate of said wireless resource, the usage rate of said network line, and wireless quality information received from a mobile terminal located within a wireless area of the own wireless base station as area status information; and
means for transmitting said area status information via said control line to said communication quality management equipment in a predetermined time interval, or in accordance with an instruction issued from said communication quality management equipment.
